(19) United States
(12) Patent Application Publication
(10) Pub. No.: US 2004/0201218 A1
(43) Pub. Date: Oct. 14, 2004

(54) Increasing the efficiency of energy generation with distributed energy storage

(76) Inventor: Lee A. Hebert, Whitinsville, MA (US)

Correspondence Address: LEE A. HEBERT, 151 HEIGHTS OF HILL STREET, WHITINSVILLE, MA, 01588, US

(21) Appl. No.: 10/185,877

(22) Filed: Jun. 28, 2002

Related U.S. Application Data
(60) Provisional application No. 60/322,275, filed on Sep. 12, 2001.

(51) Int. Cl. H02P 9/04

(52) U.S. Cl. 290/1 R

(57) ABSTRACT

An inverter/charger (14), battery (16), energy saving storage system, for storing, then inverting back to Alternating Current surplus electrical energy upon command from a controlled switch (18).

### CROSS REFERENCE TO RELATED APPLICATIONS, FED. R&D FUNDS -- N/A BACKGROUND

This application is entitled to the benefit of U.S. Provisional Pat. Application Ser. No # 60/322,275, filed 09/12/01.

### BACKGROUND—FIELD OF INVENTION

This invention relates to electrical power generation, specifically to the storage of surplus energy for use at a later point in time, to increase the overall efficiency of energy generation to use.

### BACKGROUND—DESCRIPTION OF PRIOR ART

The Utility Industry generates and distributes a source of electrical power for sale to the general public. In recent years we have come to learn that the peak demand is growing and exceeding supply.

The solution ensued all the way to the White House that the country needs to build close to 2,000 more power plants, and to exploit the Earth for the fuels to run them.

Industry responded with many new power plants already coming on line, or in the building and planning stages. This proliferation of new power plants and related news updates are published daily on the web site of www.powermarketers.com . On Jun. 19th 2002 for example top headlines read: “New power plant startups on pace for a record year”, “30% more new plants than 2001”.

The quest for more Electricity is perceived so urgent that all sources are being pursued with eagerness. From Fossil Fuels such as, Coal, Natural Gas, Oil, to Nuclear, Solar, Wind, Biomass, Geothermnal, Hydro, Fuel Cells, Distributed Generation, even using Ocean Waves.

To ensure an abundant, reliable, upon demand, source of Electricity, the Utility Industry generates surplus energy. For whatever reasons, or limitations, such as reliability, the time required to bring additional generation on line, or for other reasons of their own design, the surplus is quite massive, especially during the off peak hours.

FIGS. 1a, to 1d show the status information for the day on the California power grid (selected at random) from the California (ISO) Independent System Operators web site www.caiso.com.

The first page of each Figure is a 24-hour graph with curves plotted to represent the energy picture for the day in terms of “Available Resources”, the “Forecast Demand”, and the “Actual Demand”. The 2nd page (attached by staples) presents the same information in a numerical chart.

Surplus energy being generated and wasted on any day at random over the past year in California alone was the average equivalent energy that 400 to 700 (500 Megawatt) power plants can produce in one hour. To find the energy being wasted any day in 500 Megawatt equivalents (a large power plant) simply divide the total surplus shown for the day in the charts by 500 MW.

Utility Companies have stated that weekdays impose a greater load on the power grid than the weekends. From that statement, and being told the country does not have enough power plants to support demand; one would think that we are using more of the energy being created during weekdays, and less surplus energy would be available to save for a later point in time with my system. The following examples show this may not be true.

FIG. 1a shows the curves and charts for May 25th, 2002 a Saturday. The total surplus energy that went to waste was 315,680 Megawatts. This is the equivalent power that 631 (500 Megawatt) power plants can produce in one hour.

FIGS. 1b, 1c, and 1d show the curves and charts for Jun. 4th, Jun. 20th, and Jun. 21, 2002 which were weekdays. The total surplus energy that went to waste on Jun. 4th was 371,857 Megawatts, on Jun. 20th it was 348,234 Megawatts, and on the 21th it was 346,303 Megawatts. This is the equivalent power that 743, 696 and 692 (500 Megawatt) power plants can produce in one hour respectfully. Apparently the projected increase in load on weekdays justifies the need for more surplus energy going to waste. To me, this wasteful Industry is the Energy Crisis.

With California being the 5th largest economy in the World, the United States with California included being one of the other four; its safe to say that the energy going to waste in California alone is more than the total energy requirements of many smaller countries combined.

In fact during many off peak hours the “actual demand” shown in the charts is about the same as the surplus energy going to waste during those hours. This means the Worlds ₆th largest economy could be run on just the energy going to waste in California during those hours.

Prior art has stated, “You cannot store Electricity”, FIG. 2 is a copy of an article from the Chicago Tribune on Jun. 4, 2002, with a quotation from Mr. Richard Benedict, a Spokesman for Reliant Energy. Mr. Benedict stated, “This is the only manufacturing business where you can't store the product.”

This was also the conclusion of an analysis on Wind Energy by Stamford University Engineers, Mark Jacobson, lead Author, and Gilbert Masters Co-Author, published in the Journal Science in Aug. 2001. The analysis was also used in part in an article on the front page of the Sacramento Bee Newspaper on Aug. 24, 2001, comparing Wind Energy to Natural Gas and Coal Energy.

The article stated that Wind Energy is not available upon demand. If the wind is not blowing you have no Electricity being generated at all. The article went on to quote the analysis to say “Power from Wind Generators can't be stored and saved for later.”

Prior art such as Backup Power Systems, Uninterruptible Power Supplies and systems, referred to as a UPS, Inverter with batteries, Flywheel, and other energy storage systems, meant to provide power to a load during a power outage are passive systems.

That is, they wait for an event to happen such as a power outage, or interruption in specified performance before reacting to provide power to the load.

Ensuring a reliable, upon demand, source of Electricity from the Utility Industry with the need to waste so much surplus energy comes with a great price to the World's Natural Resources, the Environment, and the health of our citizens.

The Electrical Utility Industry is the largest industrial polluter of our environment. An enormous amount of information is available in print, in the news media, and on the Internet about power plants producing Carbon Dioxide (CO2), NOx, SO2, Mercury, and other heavy metal pollution. As such, power plants are a leading cause of Global Warming, Acid Rain, Smog, Respiratory Illness and deaths from poor air quality and heavy metal pollution.

The Utility Industry sizes it's generation capacity with the responsibility that 100% of the potential load they are chartered to support may request full power at any given point in time. To ensure an abundant, upon demand, energy source for all ratepayers they add to this a massive amount of surplus energy for reliability, and for other reasons of their own design.

FIG. 3, The Telegram & Gazette did a feature article Mar. 5th, 2002 on my energy saving storage system with inputs from Utility Company Executives representing Edison Electric, Northeast Electric, Fitchburg Gas & Electric, Unitil Corp., Mass. Electric, NSTAR Electric, Select Energy Inc., and The Department of Telecommunications & Energy, discussing the benefits my technology may offer to ratepayers on a time of use rate plan.

Utility companies have tried for many years to offer time of use rates to reduce the peak load demand but they have not been popular. Homeowners want full use of their appliances and toys when it's convenient to the homeowner, without paying a peak rate penalty to do it.

“It's really a lifestyle change that a lot of people aren't willing to make,” said Michael J. Monahan, a spokesman for NSTAR Electric.

“I think the cost of metering and control technology still has to come down a bit,” said Mr. Steve Rosenstock, Manager of Energy Solutions at the Edison Electric Institute.

“We think that's what's going to happen in the Energy Industry,” said Joel Weinberg, Spokesman for Select Energy Inc., the Marketing and Service Subsidiary of Northeast Utilities.

Prior art does not have the technology to reduce the peak load demand with a time of use rate plan and still offer full use of the home's appliances regardless of the time of use.

Prior art does not have a solution to solving the countries projected needs for more Electricity, except to build more generating capacity, wasting precious fuel and water, creating pollution.

Prior art has not developed a way for customers to timeshare a given generating capacity into time of use segments as a way to raise the generator's overall efficiency to support more load demand from the same generating capacity.

Utilities cannot separate grid tied “Green Energy” being created from Solar, Wind and other environmentally friendly generation from going to waste as part of the total surplus.

FIGS. 4a to 4f show a dip in the “actual demand” from around 10:30 AM to 4:30 PM each day, as Solar, and Wind Energy (generated by the thermal effects of the Sun), produce usable Electricity.

Conversely, as the “actual demand” decreases during the sunshine hours the surplus energy going to waste is shown as an increase by an equal amount.

Utilities cannot, or do not, for the reasons mentioned, turn down their generators just because the Sun came out, or the wind picked up. Even though they are able to forecast this energy event with amazing accuracy.

Distributed generation with or without a connection to the grid is also wasting energy in the same way as the Utility Industry if the generating capacity installed exceeds the load at any point in time.

### SUMMARY

Upon command from a controlled switch my energy saving storage system will store surplus energy for use at a later point in time. This energy savings will result in an overall increase in efficiency of energy generation to use.

### OBJECTS AND ADVANTAGES

Accordingly, besides the objects and advantages described in my above patent, several objects and advantages of my energy saving storage system are:

to store surplus energy, however generated, for use at a later point in time to increase the overall efficiency of electrical generation to use;

to increase overall reliability with a source of emergency power, for National Security, for some people such as the elderly and disabled this could be life critical;

to provide a homeowner or business a way to reduce the cost of Electricity by storing energy during the off peak for use during the peak on a time of use rate plan;

to have full use of the homes appliances and toys at any time of day for the lowest overall cost by running the home during the peak demand time on energy purchased during the off peak;

to promote saving off peak energy as “Green Energy” or as a blend of “Green Energy”, because surplus energy is a blend of all types of energy already available just going to waste;

to provide Electricity to a load from a source of stored energy, without the need to sustain a loss or interruption of utility power first, then to reconnect the load to utility power, and replenish the stored energy upon commands from a controlled switch;

to provide a way to timeshare a generators capacity into time of use segments so the same generator can accommodate a larger number of customers or an increased peak load;

to size a smaller generator to support a larger customer base by staggering the hours when individual customers or groups could reconnect to utility power for recharging the stored energy;

to provide a way to reduce generating capacity into the same or new additional load profile;

to increase overall system reliability to the individual ratepayer with backup power

to save the Utility Industry money from reliability penalties;

to provide an alternative to upgrading marginal substations to meet an increased peak load;

to provide Energy Marketers a way to purchase, store, and sell low cost surplus generation to satisfy a period of high peak demand for profit;

to give ratepayers and the environment benefit from energy they pay for anyway in the overall rate structure Utilities use to justify an abundant, reliable, upon demand, source of energy;

to advance distributed generation (DG) with an increase in reliability and efficiency.

Other objects and advantages are:

Less urgency to exploit wilderness areas for the fuels to run more power plants, a reduction in carbon dioxide, pollution and greenhouse gases could reinstate the countries leadership role in World Environmental Issues such as Global Warning and Acid Rain;

to promote cleaner air, better health, and quality of living on a Global basis; to promote deregulation and demand time trading to the individual customer level, “No thank you, I'll buy after midnight from X-Energy Corp.”;

to save on the cost of Clean Air Credits for existing generators that can be shut down as less spinning reserve is needed;

to eliminate the cost to build, fuel, and maintain as many power plants, this could result in a reduction in the price of other forms of energy to the consumer such as Natural Gas, and Oil;

to free up water for farmers, (a single power plants can use up to 8,000,000 gallons of water per day, 80% is lost to evaporation), this could increase the farmers yield and lower cost of food;

Further objects and advantages of my invention will become apparent from a consideration of the drawings and ensuing description.

### DESCRIPTION OF DRAWINGS

In the drawings, closely related figures have the same number but different alphabetic suffixes.

FIG. 1a to 1d shows the “system conditions” from the CAISO' web site on days selected at random.

FIG. 2 shows a quotation from a Utility spokesman “This is the only Manufacturing Business where you can't store the product.”

FIG. 3 shows an article printed in the Telegram & Gazette about my energy saving product.

FIG. 4a to 4f shows energy from Solar and Wind Generators as more surplus energy going waste.

FIG. 5 shows a block diagram drawing of my energy storage system.

FIG. 6 shows a photograph of my energy storage system installed in a home in Yuba City California.

FIG. 7 shows a photograph of my energy storage system set up for displaying it at home shows.

FIG. 8 shows the installation guide for my energy saving storage system.

FIG. 9 shows the installation instructions from Heart Interface, an Inverter Manufacturer.

FIG. 10a and 10b show newsprint articles on my energy saving system on 3/28/01 and 4/01/01.

FIG. 11a to 11m show letters sent to almost every U.S. Senator, Member of Congress, Governor, EPA, DOE, and Major Environmental Organizations over the past year, some of these letters were sent many times to each office, along with phones calls. I have also included a copy of a letter sent by overnight express mail to U.S. President George W. Bush on May 1, 2001.

FIG. 12a to 12i show various letters I have received in reply from Senators, Governors, State Energy Authorities, and a major Utility Company.

FIG. 13 shows the wind energy analysis quoting Stamford University Research Engineers.

REFERENCE NUMERIALS IN DRAWINGS

| | |
|---|---|
| 12 | utility power |
| 14 | inverter/charger |
| 16 | conventional storage battery |
| 18 | controlled switch |
| 20 | 115 Volt 30 Amp twist lock power cord |
| 22 | output power cord |
| 24 | input junction box and cover plate |
| 26 | output junction box and cover plate |
| 28 | circuit breaker box |
| 30 | 15 amp circuit breaker |
| 32 | 15-amp ground fault interrupter GFI |
| 34 | light duty, 115 Volt power cord |
| 36 | optional switch box |
| 38 | standard junction box |
| 40 | battery cables |
| 42 | oak base |
| 44 | load |
| 46 | 115 Volt, 30 Amp twist lock outlet |
| 48a | conduit tubing |
| 48b | conduit tubing |

### DESCRIPTION

Any commercial UPS or Battery Backup Power System (Inverter & Battery) can be used to store energy upon command by putting a controlled switch in series with the AC input power leads.

Upon local or remote, active or set commands, the controlled switch will connect or disconnect the AC input power; to select the energy-storing mode, or the energy-inverting mode of the UPS or Backup Power System being used.

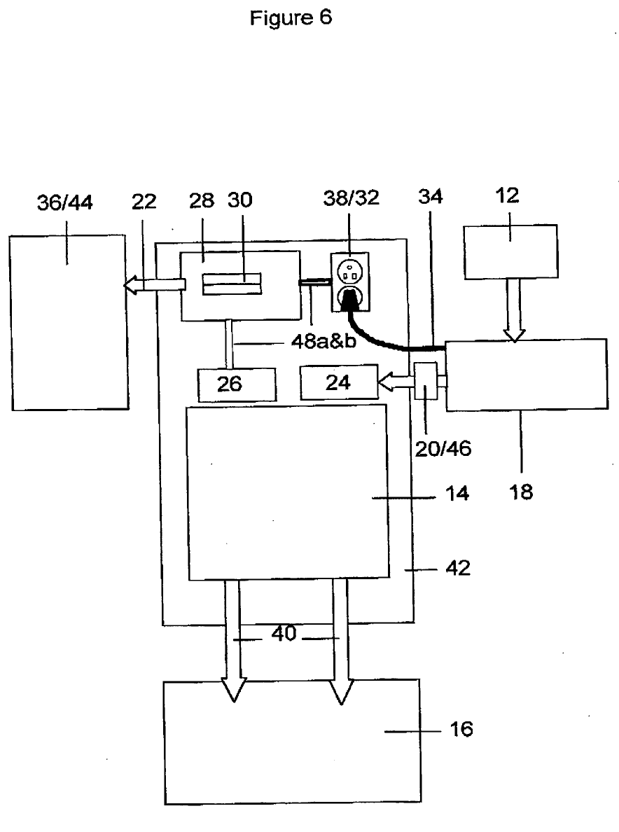

A preferred embodiment of my energy saving storage system of the present invention is shown in FIG. 6, a photograph of my energy saving storage system saving energy in a customer's home.

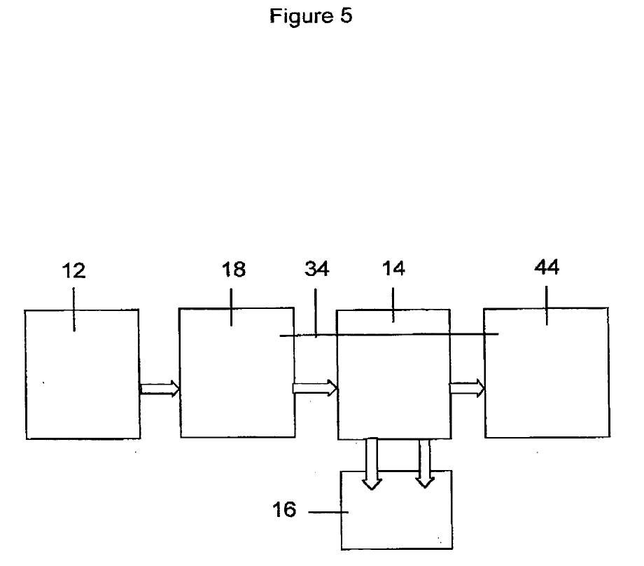

FIG. 5, is a block diagram of my energy saving storage system showing a source of Utility Power 12, wired to a controlled switch 18, in series with the AC input power leads to an Inverter 14, with a conventional storage battery 16, powering an electrical load 44.

The installation shown in FIG. 6, is using a BPS2000-25 Mr. Electricity Backup Power System from Boston Power Supplies Inc. The conventional storage battery 16, contains 8 Golf Cart (6 Volt) batteries inside of the four battery boxes shown to provide 10,000 Watts of 12 VDC energy storage.

The controlled switch 18, is a standard 115 Volt, 40 Amp Electromechanical Timer used for cycling electric hot water heaters on and off. These timer switches are readily available along with all the other components including the Inverter 14, in Hardware, Marine, and Battery Stores.

The AC power leads to the clock motor inside the controlled switch 18, were removed from the internal terminal posts and attached to a standard light duty power cord 34,.

The reason for doing this is to be able to plug the clock into an outlet that will have backup power from the system, this will keep the timer in synchronization with the peak and off peak time settings during an unexpected power outage; thus avoiding the need to constantly monitor and reset the clock.

Backup Power Systems, UPS Systems, and Inverters are commercially available from many sources. That portion of the installation should be done according to the manufacturer's instructions.

FIG. 9, is the instructions for Mr. Electricity information is also available at www.mrelectricity.com.

Other manufacturers offer complete plug and play systems such as Mr.Electricity. To convert such a product to an energy saving storage system upon command from a controlled switch all you need to do is add the controlled switch 18, in series with the input power leads.

You can also start from scratch and build your own with a properly sized Inverter and battery bank for the energy savings desired.

I have found a 2,500 Watt Inverter such as the one used for the BPS2500-25 with a battery bank of 10,000 Watts is a good size for most homes during a 6 hour peak. The average home is using a total of about 20,000 Watts per day, so 10,000 Watts should be enough to support a 6-hour peak. To build the BPS2000-25, I purchased a Freedom 25 Inverter 14, from Heart Interface Corp., in Kent Washington. FIG. 10, is a copy of the Installation Guide that came with the Freedom 25.

The Installation Guide is very complete on defining all Mechanical and Electrical requirements for installing the Heart Inverter and batteries, plus a lot of other good electrical tips.

I have chosen to build the BPS2000-25 into a complete plug and play product to enhance our product offering. This enhancement is not required to build an energy saving storage system. All that is needed is a properly sized Inverter 14, conventional storage batteries 16, and a controlled switch 18.

For the BPS2000-25 I have chosen a piece of Oak 42, to mount the components on. Any suitable base plate material can be used instead.

The Inverter 14, is mounted onto the oak base 42, along with a 30 Amp (2 position) circuit breaker box 28, and a 15 Amp ground fault interrupter (GFI) 32.

An input junction box and cover plate 24, and an output junction box and cover plate 26 are used to house the Alternating Current (AC) wiring connections to the Inverter 14, a standard junction box 38, is also used to house the GFI 32.

Mount the Inverter 14, to the 1″thick oak base 42, using #8 ×3/4″ long Stainless Steel Screws.

Mount the circuit breaker box, the input and output junction boxes and junction box for the GFI onto the oak base with 3/4′self-tapping screws. Use a section of conduit tubing 48a, between the Inverter output junction box 26, and the circuit breaker box 28. Use a section of conduit tubing 48b, between the circuit breaker box 28, and the junction box for the GFI 32, to protect the wiring between these points.

Wire a 115 Volt 30 Amp twist lock power cord 20, to the Inverter input leads in the input junction box 24, white-to-white, green-to-green, and black-to-black.

Wire the Inverter's output to the breaker box 28, using 10-gauge wire. The green or copper wire goes to case ground, the black wire to the “Hot” lugs, and the white to the neutral terminal. See the instructions that come with the breaker box for proper locations. Using a 15 Amp circuit breaker 30, wire the GFI 32, to the circuit breaker 30, with 12-gauge wire. The black wire goes on the breaker 30, the white wire to neutral and the green or copper to case ground.

See the instructions that come with the GFI and breaker box for the proper locations.

An output power cord 22, is normally added by the installing electrician where the actual length may vary from installation to installation. Our installation notes specify using 10-gauge copper wire for the output power cord.

The output power cord 22, was constructed out of 10-4 SO Cable. Both the red and black leads are connected to the same lug used for the black lead from the Inverter 14, to the circuit breaker box, then white to neutral and green to case ground. See the breaker box instructions for the proper locations. The output power cord mates with the input connector of an optional switch box 36.

Another choice would be to wire your circuit loads directly to the circuit breaker box 28, or to use a standard sub-panel of circuit breakers instead of the optional switch box 36.

However the switch box 36, comes pre-wired and will shorten your Electricians installation time.

The input power cord plugs into a mating 115 Volt 30 Amp twist lock outlet 46, which is then wired to the controlled switch 18, in series to Utility Power 12. The light duty power cord 34, put on the clock motor leads is plugged into the GFI 32.

Connect the battery cables 40, from the Inverter to the Battery being careful to observe polarity. The Red tipped lead to (+) positive, Black tipped lead to (−) minus. A picture of how to wire multiple 6 Volt Golf Cart Batteries to construct a large 12 Volt battery bank is included in FIG. 8.

Operation

FIG. 6 is a photograph of my energy saving storage system installed in a customer's home in Yuba City, Calif. The homeowners have dramatically reduced their monthly and annual cost for Electricity since the Feb. 2001 installation. The home is on a time of use rate plan offered by PG&E of $0.35 per KWHR during the six-hour peak, and $0.06 per KWHR the rest of the day.

My energy saving storage system removes the electrical loads of the appliances wired to it from Utility Power, and onto the energy stored in the batteries at noon. At 6 pm the loads are returned to Utility Power and the system recharges the storage batteries for the next day, or of course an unexpected power outage. This cycling is an automatic function of the controlled switch everyday.

This same system could be provided with a controlled switch commanded from a remote location by a power provider or even a homeowner to shed load at anytime to avoid a blackout, a load emergency, or at the power provider's or homeowner's whim and fancy to profit from market signals.

FIG. 5, is a block diagram of my energy storage system. Utility Power 12, is wired in series to a controlled switch 18, to an Inverter/Charger 14, to a conventional storage battery 16, and a load 44.

The Inverter/Charger 14, will rectify Utility Power (AC) Alternating Current to (DC) Direct Current for storage in the battery 16 whenever the contacts in the controlled switch 18, are closed; that is whenever Utility Power is being made available to the Inverter/charger 14, and to the load 44.

Upon opening the contacts of the controlled switch 18, the Inverter 14, will continue providing power to the load by inverting the DC Energy stored in the battery back to Alternating Current.

Conclusion, Ramifacations, And Scope Of Invention

Thus the reader will see that the controlled storage of surplus energy for use at a later point in time will have a constellation of positive benefits for Mankind, the environment, and the global community of all living things.

While my above description contains many specificities, these should not be construed as limitations on the scope of the invention, but rather an exemplification of one preferred embodiment thereof

Many variations are possible, for example my energy storage system can be scaled up and down in power, input and output variations, including but not limited to Voltage, Frequency, number of input phases and switch contacts, storage capacity, Power Factor, remote or local control, individual or grouped locations, battery types, size and voltage, other energy storage technologies, and methods of control.

The controlled switch can be sized up and down in the number of contacts, Voltage and Current rating, location, serving individual or multiple locations, method of control from Mechanical, Electromechanical, Electronic, manual, wired or wireless, self powered, wound spring, solar, Electrical, magnetically coupled, liquid, vapor, pressure, vacuum or any combination of the above, that will make and break an electrical contact, or contacts, wired in series with the energy source going to either the AC power input leads or directly to the battery as DC energy storage.

An example of a commercially available contactor switch with a wireless control signal is the type used by Utilities to remotely control large Air Conditioners and other large electrical loads under various load shedding plans they offer.

In this case, the controlled switch is most likely a Single or Multiple Phase, Electromechanical or Solid State Relay wired in series with Utility Power to the Air Conditioner's Compressor.

A wireless receiver (similar in function to a personal beeper) can be used to signal commands to a low voltage source (typically 12 or 24 VAC from a step down transformer off the mains), or battery.

This low voltage source is energized by the closing of a switch wired in series with it. The series switch is opened and closed upon commands sent to the wireless receiver. When the low voltage source is energized it provides power to a holding coil or Electronic Solid State devise controlling the main contactors.

The Controlled switch could also be accomplished with a Mercury Relay, a Solid State Relay or a Programmable Logic Controller, with local or remote control, with or without the wireless receiver.

Mercury Relays are being mentioned to complete this section only. Mercury is an environmental nightmare and its use should be limited or phased out entirely wherever possible.

Accordingly, the scope of the invention should be determined not by the embodiments illustrated, but by the appended claims and their legal equivalents.

I Claim:

1. A method for increasing the efficiency of electrical generation comprising the steps of:
(a) providing a means for converting an alternating current energy to a direct current energy in a storage medium, (b) providing a means for controlling the point in time to convert said alternating current energy to said direct current energy in said storage medium, (c) providing a means for inverting said direct current energy in said storage medium to a reconstituted alternating current energy, (d) providing a means for controlling the point in time to invert said stored direct current energy to said reconstituted alternating current energy, whereby surplus electrical energy generated at one point in time can be used for electrical work at another point in time, increasing the overall efficiency of electrical energy generation to use, whereby an increase in efficiency could result in substantially less wasteful energy generation, and substantially less environmental damage from pollution generated to support the same load.

2. The method of increasing the efficiency of electrical generation of claim 1, wherein comprising the steps of:
(a) providing a plurality of said means to increase the efficiency of electrical generation, (b) providing a means to control the point in time an individual or a group of individuals taken from said plurality could recharge said storage medium, whereby a substantially greater number of customers or a substantially greater load demand spread out over time, can be accomplished from a given generating capacity than would otherwise be possible, whereby a reduction in pollution and waste of our natural resources could be realized over the need to run a generating capacity large enough to support 100% of the loads at the same point in time.

3. The method of claim 2, controlling the point in time to recharge said storage mediums wherein (a) providing a knowledge of green energy available at a given point in time said groups could be controlled to store surplus energy at that exact point in time, whereby full use of environmentally friendly generation could be realized before the need to run additional environmentally harmful generation occurred. whereby the entire global community of life will benefit from a cleaner healthier environment,

4. A machine for increasing the efficiency of electrical energy generation, comprising:
(a) a means to convert an alternating current to a direct current in a storage medium, (b) a means for controlling the point in time for converting said alternating current to said direct current in said storage medium, (c) a means to invert said direct current in said storage medium to a reconstituted alternating current, and (d) a means for controlling the point in time for inverting said direct current in said storage medium to said reconstituted alternating current, whereby surplus electrical energy generated at one point in time can be used for electrical work at another point in time, increasing the overall efficiency of electrical energy generation to use, whereby an increase in efficiency could result in substantially less wasteful energy generation, and substantially less environmental damage from pollution generated to support the same load.

5. The machine for increasing the efficiency of energy generation of claim 4, wherein comprising the steps of:
(a) a plurality of said means to increase the efficiency of electrical generation, (b) a means to control the point in time an individual machine or a group of machines taken from said plurality could recharge said storage medium, whereby a substantially greater number of customers or a substantially greater load demand spread out over time, can be accomplished from a given generating capacity than would otherwise be possible, whereby a reduction in pollution and waste of our natural resources could be realized over the need to run a generating capacity large enough to support 100% of the loads at the same point in time. whereby increasing the overall efficiency of electrical generation to end use with substantially increased system reliability to the individual ratepayer with a source of emergency power and the potential for a substantial saving from purchasing energy off peak that would only be going to waste, while helping mankind regain a cleaner, healthier environment for future generations.

6. I claim a means to convert surplus utility energy into free energy or to a least be considered a form of green energy, because mankind and all the wonders of nature living in the environment God made for us have already paid the price to create it once.
